(19) United States
(12) Patent Application Publication
(10) Pub. No.: US 2005/0176491 A1
(43) Pub. Date: Aug. 11, 2005

(54) Game of chance and system and method for playing games of chance

(76) Inventors: Steven N. Kane, Brookline, MA (US); Stuart Roseman, Boston, MA (US); Jason Yanowitz, Amherst, MA (US); Mark E. Herrmann, Wellesley, MA (US)

Correspondence Address: LOWRIE, LANDO & ANASTASI, RIVERFRONT OFFICE, ONE MAIN STREET, ELEVENTH FLOOR, CAMBRIDGE, MA, 02142, US

(21) Appl. No.: 10/954,985

(22) Filed: Sep. 30, 2004

Related U.S. Application Data
(63) Continuation-in-part of application No. 10/729,826, filed on Dec. 5, 2003.
(60) Provisional application No. 60/431,036, filed on Dec. 5, 2002.

(51) Int. Cl. A63F 13/00

(52) U.S. Cl. 463/19

(57) ABSTRACT

An electronic game of chance is provided in which variations of the United Kingdom version of the game of chance bingo is played. A player may pay to play through a subscription that may also be automatically renewed. A subscription to the game may also be obtained through an alternative method of entry (AMOE). In one variation, numerous winners may occur per game session because the game continues until the predetermined fixed number of winning cell content is drawn and not until a win occurs.

### RELATED APPLICATIONS

This application claims priority under 35 U.S.C. § 119(e) to U.S. Utility application Ser. No. 10/729,826, entitled “GAME OF CHANCE AND SYSTEM AND METHOD FOR PLAYING GAMES OF CHANCE,” filed on Dec. 5, 2003, which claims priority under to U.S. Provisional Application Ser. No. 60/431,036, filed on Dec. 5, 2002, entitled “GAME OF SKILL AND CHANCE AND METHODS FOR PLAYING GAMES OF SKILL AND CHANCE,” each of which applications are herein incorporated by reference by their entirety.

### FIELD OF THE INVENTION

The present invention relates to games of chance and, more particularly, to methods of and systems for playing games of chance.

### DESCRIPTION OF THE RELATED ART

Legalized public and private bingo games abound in the United States and throughout the world. Bingo-type games involve a plurality of participants each having at least one pre-printed playing card. Typically, bingo playing cards comprise five columns, corresponding to the letters “B”, “I”, “N”, “G” and “O”, whence the game derives its name, and five rows in a boxed matrix. Numbers and/or free spaces populate the boxes in the matrix.

The game of bingo is played by randomly selecting winning numbers from a population of numbers. In a traditional bingo game, a participant wins when a combination of selected winning numbers covers at least one row, column, and/or diagonal of five numbers on at least one participant's playing card. However in many bingo games, numerous other patterns that have been predetermined may also be used for winning; these patterns include those known as Hard Way (five-in-a-row without using the free spot), Six Pack (2×3 or 3×2 matrix), or Small Kite. When a participant covers a winning pattern with winning numbers, he or she declares “Bingo!” Verification of the win occurs immediately and if the win is verified, the game ends and no further numbers are drawn. Generally, there is only a single winner for each game; if there are multiple winners, the prize is divided equally among all winners.

In the United Kingdom and Australian, bingo cards have three rows and nine columns and usually come in single and multiple books. A single book typically contains ten pages (ten cards), each of a different color.

A multiple book includes six single books. Each page in a multiple book includes six cards of the same color. The six cards are printed on a single page and are joined with perforated edges which can be pulled apart. Typically, experienced players play all six books, but inexperienced players may only play one book, or even a single card.

In addition to the books described above, there are also single sheets of bingo cards sold with six sections (six cards) and these are called “flyers”. A player can buy just one section or all six sections.

Because bingo card formats are different in the United Kingdom and Australia, the numbers are assigned differently on the cards. Fifteen of the cells in each ticket matrix are assigned a unique number prior to the commencement of each game session from the universe of 90 possible numbers (1 to 90). Each row randomly contains five cells with numbers and four blank cells. The cells in the columns are randomly assigned numbers in the following manner:

| | | |
|---|---|---|
| Column 1: | 1-9 | 9 Total |
| Column 2: | 10-19 | 10 Total |
| Column 3: | 20-29 | 10 Total |
| Column 4: | 30-39 | 10 Total |
| Column 5: | 40-49 | 10 Total |
| Column 6: | 50-59 | 10 Total |
| Column 7: | 60-69 | 10 Total |
| Column 8: | 70-79 | 10 Total |
| Column 9: | 80-90 | 11 Total |

In each column, numbers appear in numerical order from top to bottom.

With six cards on a multiple book page or flyer, all 90 numbers are used once on a page or flyer. Additionally, there is a restriction that no column can be blank. That is, each column must contain at least one cell with a number.

The play of bingo in the United Kingdom and Australia proceeds in a similar manner to a standard bingo game having wins that usually occur when five numbers in one row of a card have been drawn (or called).

There is a present and recurring need for new games of chance that are easy to understand, are easy to play, and are accessible while still able to have more than one winner. Such a game is needed to attract new game players and to provide existing players with another game of chance.

### SUMMARY OF THE INVENTION

One aspect of the invention provides a game that has a game session that includes one or more game players, each having one or more game pieces, which themselves each have one or more game cards. Each game card has cells arranged in a pattern predetermined for the game session and has each cell filled with content randomly by a game operator or computer from a predetermined set of cell content for the game session; as used herein, a “set” of items may include one or more of such items. A predetermined fixed number of winning cell content is then randomly drawn and matched to the content of each game card. The game player holding a winning game card is then paid according to a predetermined payout table associated with the game session.

According to one aspect of the present invention, a wagering game of chance is provided wherein a game player subscribes to play multiple game sessions. The game comprises one or more game pieces assigned to each player, wherein each game piece includes one or more game cards, wherein each of the one or more game cards includes two or more groupings of a plurality of cells arranged in a pattern, wherein each of the one or more game pieces includes a set of game cards having a same set of two or more groupings of a plurality of cells arranged in a pattern, and wherein the number of total cells on each of the one or more game cards that contains content chosen randomly from a predetermined set of cell content is equal to the number of items in the predetermined set of cell content, a winning pattern for the game session, a fixed number of winning cell content drawn from a known set of content, and a payout based upon a predetermined payout table.

According to one embodiment, the content of the cells is evenly distributed among all the rows or columns of cells in the two or more groupings of cells on a game card. According to another embodiment, every game piece assigned in a game session is unique. According to another embodiment, every card in a game session is unique. According to another embodiment, every grouping of a plurality of cells in a game session is unique. According to another embodiment, the predetermined set of cell content includes at least one of a number, a letter, a shape, a symbol, a color, a logo and a drawing.

According to one embodiment, each item in the predetermined set of cell content is used only once on each game card. According to another embodiment, the cell content may be at least one of a free spot and a wild spot. According to another embodiment, the predetermined set of cell content is divided into subsets, at least one of which is assigned for use in a particular group of cells. According to another embodiment, every row and column in the two or more groupings of a plurality of cells has at least one cell containing one or more items from the predetermined set of cell content.

According to one embodiment, the grouping of a plurality of cells includes 3 rows and 9 columns. According to another embodiment, the grouping of a plurality of cells is 9 rows and 3 columns. According to another embodiment, the player pays to play with at least one of money and loyalty points. According to another embodiment, the player pays by at least one of cash, a debit card, a credit card, an account credit, and a loyalty program credit. According to another embodiment, the player is permitted to automatically renew the subscription. According to another embodiment, each player plays against an operator of the game. According to another embodiment, each player plays against the other players. According to another embodiment, each player plays the game on at least one of a television, a personal computer, a kiosk, a handheld device, a telephone having a display, a kiosk and in person.

According to one embodiment, the payout for winning depends upon the number of winning cell content drawn before obtaining the winning pattern. According to another embodiment, the payout for winning decreases as the number of winning cell content drawn increases to obtain the winning pattern. According to another embodiment, the payout for winning to a player is increased with a corresponding increase in payment by the player to play. According to another embodiment, the payout to a player for winning the game is divided among each of a plurality of winning players. According to another embodiment, there may be at least one progressive jackpot. According to another embodiment, the payout table is not directly determined by the odds of winning with or without a fee to the gaming operator.

According to one embodiment, the payout for winning may include at least one of money, a credit, merchandise, and loyalty points. According to another embodiment, the payout for winning money is performed by providing at least one of cash, a check, a debit card, and an account credit. According to another embodiment, the payout for winning loyalty points is performed by providing at least one of a loyalty program credit and an account credit. According to another embodiment, the game sessions are run continually. According to another embodiment, a game playing computer system randomly picks the winning cell content from a predetermined set of content.

According to one embodiment, the player manually daubs his or her at least one game card. According to another embodiment, the player tells the gaming operator or computer system that the game winning pattern has been matched. According to another embodiment, the player and the winning game card must be verified and authenticated by the gaming operator or computer system. According to another embodiment, a game playing computer system displays to all players when there is a winner. According to another embodiment, a game playing computer system displays to all players at least one of the winning game card and the winning player.

According to one embodiment, a game playing computer system determines at least one of a game card or a player closest to winning. According to another embodiment, a game playing computer system displays to all players at least one of the game card and player closest to winning. According to another embodiment, a game playing computer displays to each player the game card or grouping of a plurality of cells of his or her own that is closest to winning. According to another embodiment, the computer system automatically notifies a player of winnings. According to another embodiment, a player may access his or her results for past gaming sessions remotely at any time. According to another embodiment, the results for past gaming sessions are at least one of a win, a payout, and a loss. According to another embodiment, a player gains remote access through at least one of a group including a kiosk, a phone, a handheld device, a television and a computer.

According to one embodiment, a player replays a past game session remotely at any time. According to another embodiment, a player gains remote access through at least one of a group including a kiosk, a telephone having a display, a handheld device, a television and a computer. According to another embodiment, the game sessions are run continually, and wherein advertising streams are inserted into the display during the game session. According to another embodiment, the player may enter a game session through an alternative method of entry (AMOE). According to another embodiment, the game and its associated game session are played using one or more computer systems.

According to one embodiment, the cells of each of the one or more game cards is chosen randomly by a computer system. According to another embodiment, the game is available on a network. According to another embodiment, the network is a cable system, the Internet, or wireless. According to another embodiment, each game session includes at least two winning patterns. According to another embodiment, the at least two winning patterns have progressive complexity. According to another embodiment, a winning pattern is no longer available after being matched for a win by at least one of the players. According to another embodiment, the payout table is adjusted for at least one of a time of day and a day of the week of the game.

According to one embodiment, the payout table is adjusted for at least one of a number of subscribers and a number of actual players. According to another embodiment, the player daubs cell content matching drawn winning cell content by selecting the matching cell content. According to another embodiment, the player daubs all cell content matching a drawn winning cell content by selecting a listing of drawn winning cell content. According to another embodiment, the player daubs all cell content matching a drawn winning cell content by selecting a listing of recent drawn winning cell content. According to another embodiment, the grouping of a plurality of cells is nine rows by three columns.

According to another aspect of the present invention, a method is provided for playing a wagering game of chance. The method comprises acts of assigning one or more game to each player, wherein each game piece includes one or more game cards, wherein each of the one or more game cards includes two or more groupings of a plurality of cells arranged in a pattern, wherein each of the one or more game pieces includes a set of game cards having a same set of two or more groupings of a plurality of cells arranged in a pattern, and wherein the number of total cells on each of the one or more game cards that contains content chosen randomly from a predetermined set of cell content is equal to the number of items in the predetermined set of cell content. The method further comprises acts of determining a winning pattern for the game session, drawing a fixed number of winning cell content from a known set of content, and determining a payout based upon a predetermined payout table.

According to one embodiment, the method further comprises an act of distributing content among the plurality of cells evenly across all the rows or columns of cells in the two or more groupings of cells on a game card. According to another embodiment, the method further comprises an act of assigning a unique game piece in a game session. According to another embodiment, the method further comprises an act of assigning a unique game card in a game session. According to another embodiment, the method further comprises an act of assigning a unique grouping of a plurality of cells in a game session. According to another embodiment, the method further comprises an act of determining the payout based on the number of winning content drawn before obtaining the winning pattern. According to another embodiment, the method further comprises an act of decreasing the winning payout and the number of winning content drawn increases. According to another embodiment, the method further comprises an act of increasing the payout for winning to a player with a corresponding increase in payment by the player to play. According to another embodiment, the method further comprises an act of permitting an entry into a game session through an alternative method of entry (AMOE). According to another embodiment, the grouping of the plurality of cells is formed in nine rows by three columns.

According to another aspect of the present invention, a system is provided for playing a wagering game of chance. The system comprises means for assigning one or more games to each player, wherein each game piece includes one or more game cards, wherein each of the one or more game cards includes two or more groupings of a plurality of cells arranged in a pattern, wherein each of the one or more game pieces includes a set of game cards having a same set of two or more groupings of a plurality of cells arranged in a pattern, and wherein the number of total cells on each of the one or more game cards that contains content chosen randomly from a predetermined set of cell content is equal to the number of items in the predetermined set of cell content. The system further comprises means for determining a winning pattern for the game session, means for drawing a fixed number of winning cell content from a known set of content, and means for determining a payout based upon a predetermined payout table.

According to one embodiment, the system further comprises means for distributing content among the plurality of cells evenly across all the rows or columns of cells in the two or more groupings of cells on a game card. According to another embodiment, the system further comprises means for assigning a unique game piece in a game session. According to another embodiment, the system further comprises means for assigning a unique game card in a game session. According to another embodiment, the system further comprises means for assigning a unique grouping of a plurality of cells in a game session. According to another embodiment, the system further comprises means for determining the payout based on the number of winning content drawn before obtaining the winning pattern. According to another embodiment, the system further comprises means for decreasing the winning payout and the number of winning content drawn increases. According to another embodiment, the system further comprises means for increasing the payout for winning to a player with a corresponding increase in payment by the player to play. According to another embodiment, the system further comprises means for permitting an entry into a game session through an alternative method of entry (AMOE). According to another embodiment, the grouping of the plurality of cells is formed in nine rows by three columns.

Further features and advantages of the present invention as well as the structure of various embodiments of the present invention will be more fully understood from the examples described below with reference to the accompanying drawings. The following examples are intended to illustrate the benefits of the present invention, but do not exemplify the full scope of the invention. All references cited herein are expressly incorporated by reference.

### BRIEF DESCRIPTION OF THE DRAWINGS

In the drawings,

FIG. 1 is a user interface associated with a game according to one embodiment of the invention;

FIG. 2 is a diagram showing a flow chart of a process for playing a game card according to one embodiment of the invention;

FIG. 3 is a block diagram showing an interrelationship between game sessions, players and cards according to one embodiment of the invention;

FIG. 4 is a diagram showing components of a game session according to one embodiment of the invention;

FIG. 5 is a diagram showing components of a game computer system according to one embodiment of the invention;

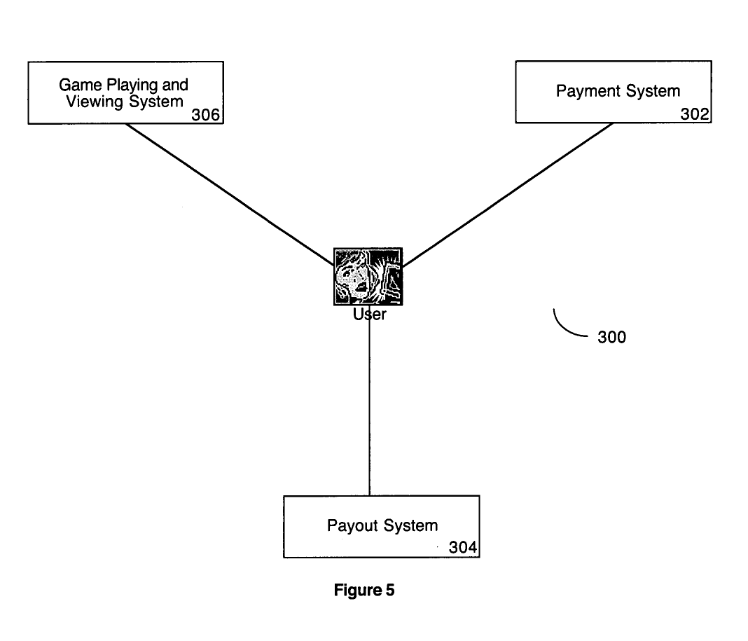

FIG. 6 is a diagram showing components of a game payment subsystem according to one embodiment of the invention;

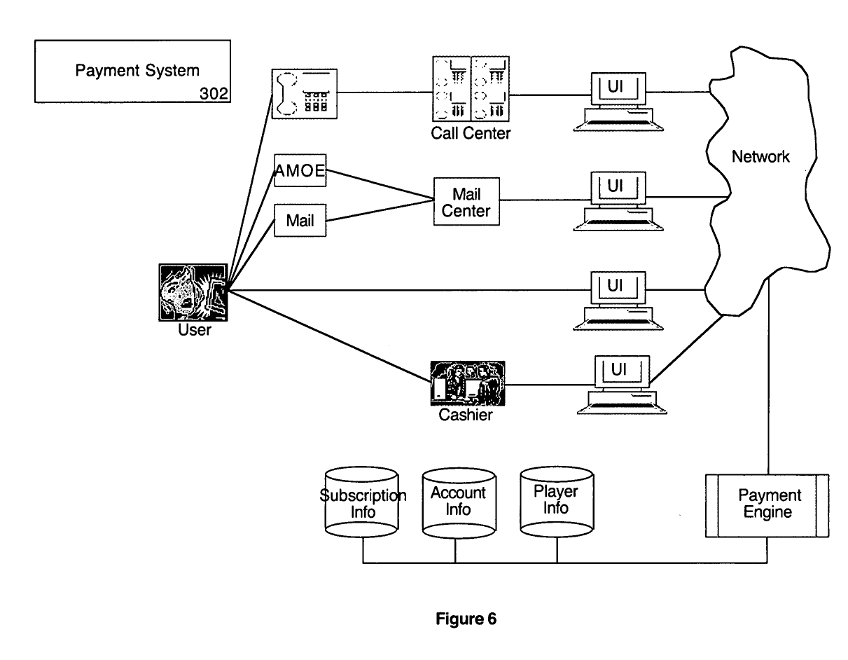

FIG. 7 is a diagram showing components of a game payout subsystem according to one embodiment of the invention;

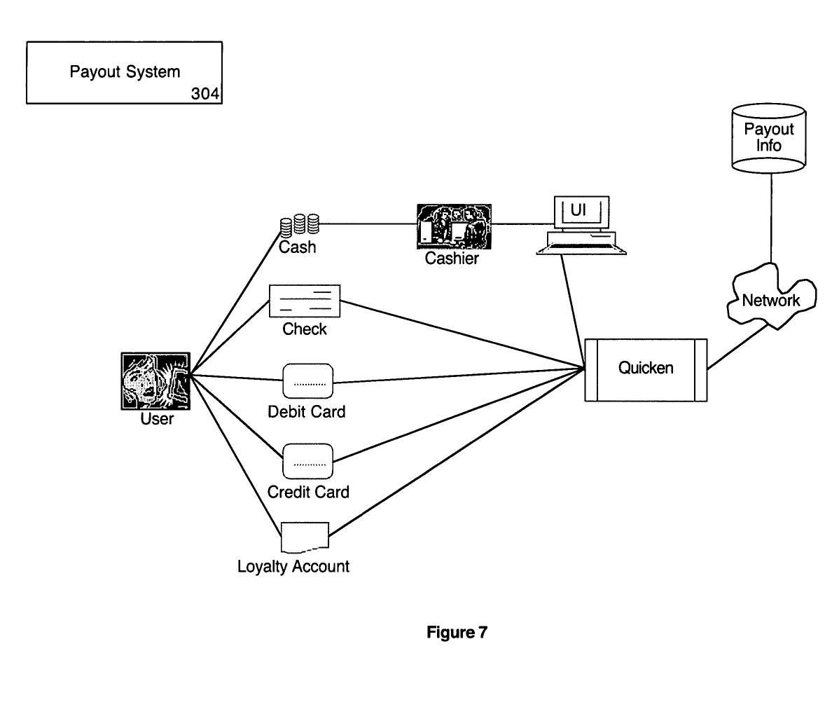

FIG. 8 is a diagram showing components of a game playing and viewing subsystem according to one embodiment of the invention;

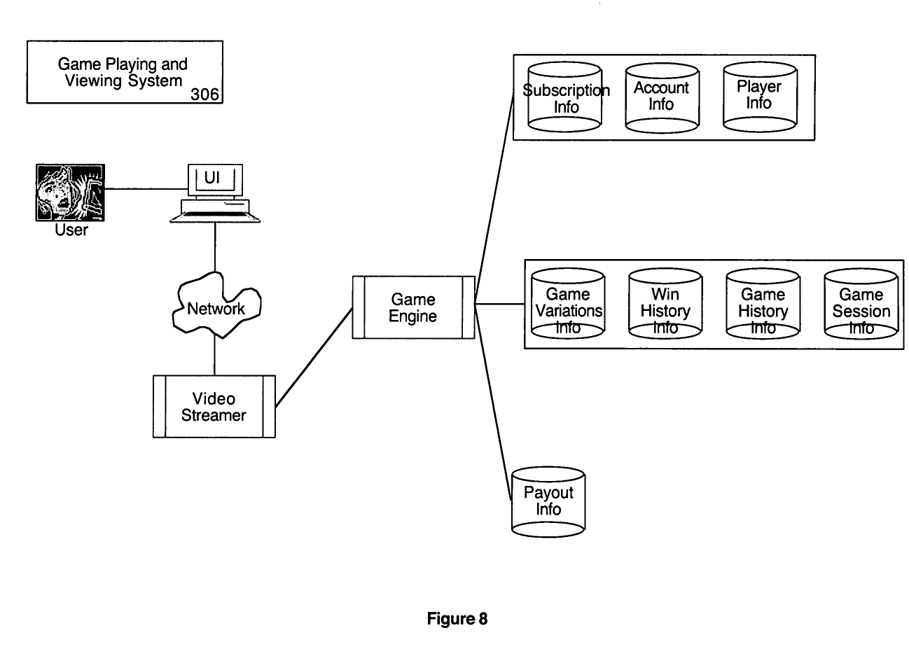

FIG. 9 is a block diagram of a general-purpose computer system upon which various embodiments of the invention may be implemented; and

FIG. 10 is a block diagram of a computer data storage system with which various embodiments of the invention may be practiced.

### DETAILED DESCRIPTION OF THE INVENTION

One aspect of the invention relates to a new game that includes elements of the United Kingdom (UK) version of the game of chance known as bingo. There are advantages of this type of game that make the UK version of bingo attractive for online gaming. The inventive game makes use of the advantages of Bingo by being a variation on the game but because of its novelty, the inventive game will attract new players to the online gaming community.

Prior to a game session, a game player may need to pay for playing. For example, a game player may pay using money or loyalty points. In particular, a game player may pay using money by debit card, credit card, check, cash or from an account credit either with the gaming operator or an affiliated organization. Alternatively, a game player may pay using loyalty points from an account held either by the gaming operator or by an affiliated organization. Loyalty points may be obtained from any type of organization but are generally associated with loyalty programs such as frequent flier programs for airlines, frequent stay programs for hotels or frequent visitor programs for casinos. The game player may pay in person (e.g., by using a cashier or lottery agent) or by other remote methods including telephone, handheld device, kiosk, computer through the Internet or other network and mail. Payment may be in any form that is legal in the particular jurisdiction.

In one embodiment of the invention, players may subscribe to play multiple and/or consecutive games. That is, the player pays at one time to play many games. According to one embodiment, such players may subscribe to multiple games (e.g., fixed-odds or non-fixed odds games) using a computer-based interface (e.g., a personal computer, cell phone, PDA, set-top box or other interface). These subscribed games may be automatically played (e.g., by a computer system) without the need to interact with the game provider as discussed more fully below. In another embodiment, the player may also choose to have his or her subscription automatically renewed.

According to one embodiment of the invention, players may also enter to play this or any other wagering game of chance using an alternative method of entry (AMOE). AMOE is a required available method of entry that does not require a purchase to enter a sweepstake; sweepstakes are usually used as a promotional or marketing tool. An individual entering a sweepstakes by AMOE is required by law to have the same odds of winning each of the available prizes.

A common AMOE method is to have an individual interested in entering the sweepstakes send in a postcard with his or her name, address or other contact information. Another AMOE method is to have an individual sign on to a free internet website and submit the required information for free. Numerous other methods may be used for AMOE. Most sweepstakes limit the number of times one individual or family may enter a sweepstakes by AMOE.

According to one embodiment of the invention, it is realized that an AMOE (alternative method of entry) may be used to enter a game of chance. More particularly, it is possible to develop, implement and run wagering games of chance, including the inventive games described herein, with an AMOE method of entry. AMOE methods are conventionally used to enter a player in a sweepstakes, which is not considered wagering or gambling. Thus, according to one embodiment of the invention, an individual may enter a wagering game of chance by AMOE using, for example, the post card or the online method outlined above. The wagering game of chance player entering by AMOE may also have the same odds to win the payout associated with the game session in which they are entered. The wagering game of chance player entering by AMOE may also be limited to a small number of game sessions within a given period of time, for example one game session in one year or two game session in one month. Other numbers of sessions and given periods may be any number, and the invention is not limited to any particular implementation.

According to one embodiment, the game session into which the game player enters by AMOE may be determined by the game player on the AMOE entry form. For example, the post card AMOE may be required to state the date and the time of the game session that the game player wants to enter. Alternatively, the game session entered may be the next starting game session after the AMOE is received and logged. As another alternative, AMOE entries may be assigned to a specific game session(s) each hour, day, week or other time interval.

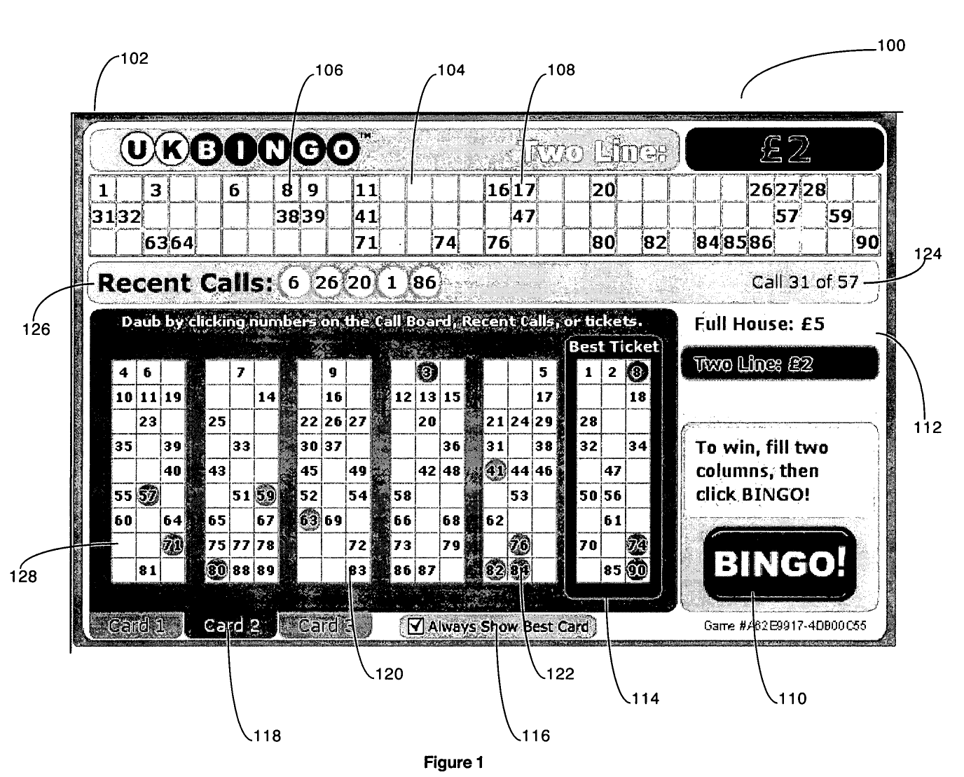

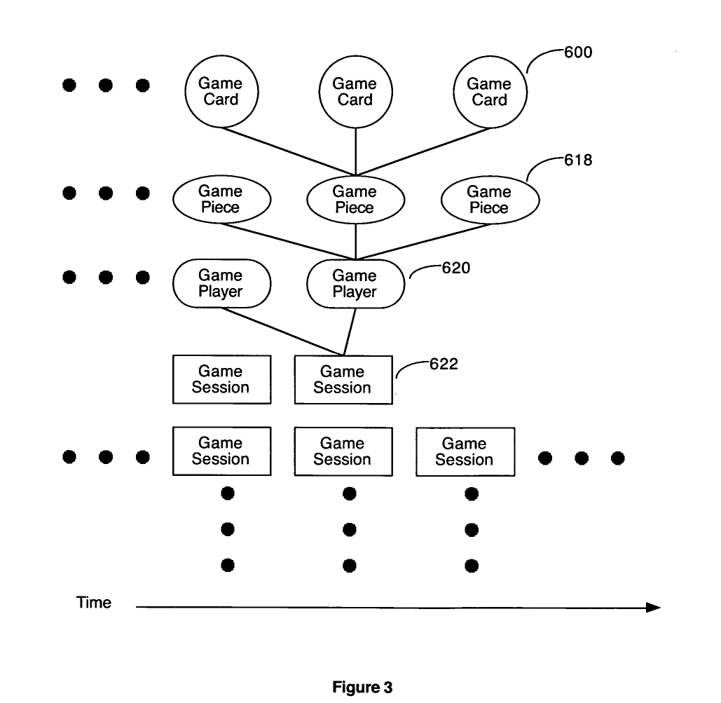

FIG. 3 shows an example relationship between time, game sessions, game players, game pieces and game cards according to one embodiment of the present invention. As shown in FIG. 3, the three dots denote when an item may proceed ad infinitum. For example, a player can play one or more game pieces (e.g., from one piece up to a very large number of pieces). As discussed above, a player 620 may pay for the game or obtain access to the game through AMOE. A game player (e.g., player 620) may play at least one game piece 618 (or 102 in FIG. 1) for a particular game session 622. Also, a player may have as many game pieces 618 as they desire to play in each session (e.g., session 622). Each game piece 618 may then be made up of one or more game cards 600 (or 118 in FIG. 1). According to one embodiment, the number of game cards 600 per game piece 618 may be predetermined (that is, determined at any time prior to the beginning of the game session, e.g., one second or one year in advance) for each game session 622. It may also be possible that each game card 600 within a game piece 618 has a different card pattern, different winning pattern, predetermined cell content set or any other predetermined parameter.

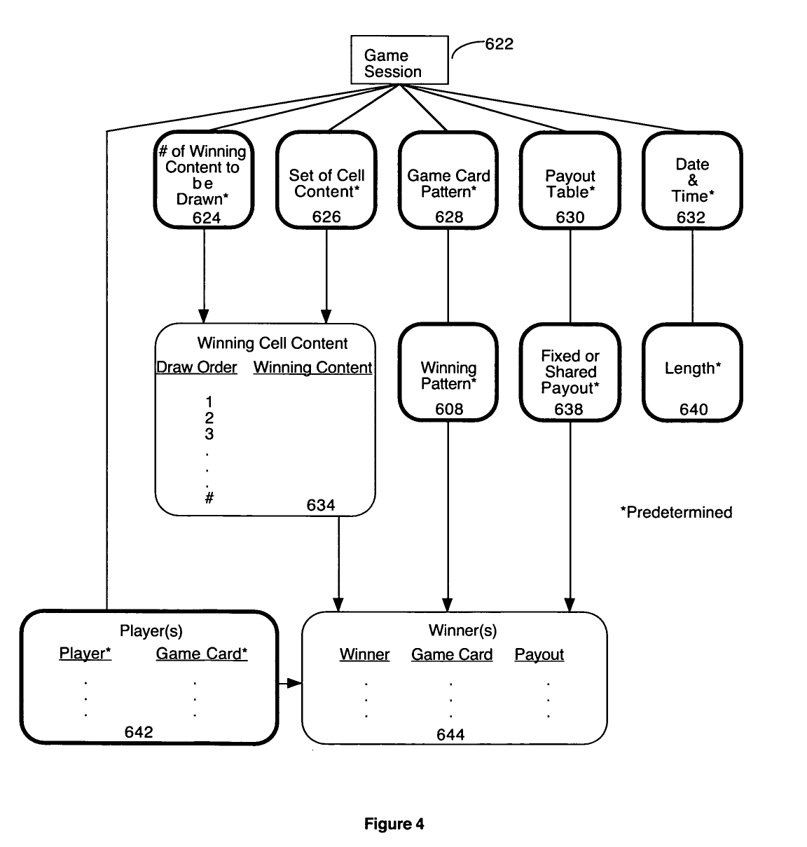

Referring to FIG. 1, a game card 118 (item 600 of FIG. 3) includes a number of groups 114 of cells 128. Each player in a game session 622 has at least one game card 118 with the same pattern or matrix of cells 128 (item 628 of FIG. 4). In one embodiment, some cells 128 of each game card 118 have a cell content 120. In one embodiment, cell content 120 is one of a predetermined set of cell content (item 626 of FIG. 4) for a particular game session 622. Cell content 622 may include, for instance, integers from 1 to 90 or English letters from A to Z or any combination thereof.

Cells 128 of the game card 118 in each session may be subdivided into groups, each of which includes a subset of possible cell content (e.g., as outlined above for the United Kingdom version of bingo). Preferably, every game card 118 is unique within a particular game session 622, although duplicate cards may exist.

As shown in FIG. 1, one embodiment of the invention has each game card with six groups of cells arranged in a pattern, e.g. in nine rows by three columns. Each column then has five cells with numbers that have been assigned to the rows following similar rules as used for the United Kingdom version of bingo (except columns are exchanged for rows).

According to one embodiment of the invention, the object of a game of chance is to match cell content of a particular game card with the drawn winning cell content (item 108) and to have the matched cell content cover at least the predetermined winning pattern 112. In FIG. 1, for example, winning pattern 112 is listed as a two-line win (two columns fully-covered) and a full house (all numbers covered in a group of cells). A player having any winning pattern showing in the list of predetermined winning patterns could win the game. Further, a game may have more than one predetermined winning pattern (possibly of progressive complexity). For instance, the game may have three winning patterns including a Single Line, a Two Line, and a Full House (Three Line) winning pattern. Multiple predetermined winning patterns make each game actually have a plurality of different games within one game.

When the game is played as a multi-player game with each player playing against each other, a predetermined winning pattern may no longer be available to win after the first player (or players in the event of a tie) has matched that winning pattern. When this happens, the appearance of the card may change. For example, the ticket, background, card background or cell content color may change. Card appearance may also change dependent upon the total number of winning cell content drawn or any other criterion.

Initially, because no winning cell content has yet been drawn, each game card does not have matching cell content. Winning cell content is drawn from the predetermined set of cell content (e.g., item 626 of FIG. 4). In one embodiment, winning cell content may be drawn one at a time up to a predetermined fixed number of drawn winning cell content (e.g., item 624 of FIG. 4).

Because it may be possible to have more than one game card 118 per game piece 618, a winning pattern may also cover more than one group 114 of cells. For example, the winning pattern may be covering the first column of all cell groupings 114 for a game card 118. Alternatively, for a game card 118 containing six cell groupings the winning pattern may be obtained by matching all numbers in a column for any of the six cell groupings.

According to one embodiment, a game session 622 also includes an associated predetermined payout table (item 630 of FIG. 4). Payout table 630 may include a listing of the ways to obtain a payout and its payout amount. Possible ways to obtain a payout include, for example, matching at least the winning pattern 608, matching only the winning pattern, matching part or none of the winning pattern, and matching none of a group of cells.

The payout amount for each method of winning may depend at least in part upon the odds of obtaining the particular way to obtain a payout in the predetermined fixed number of drawn winning cell content. For example, the odds of matching a winning pattern with thirty winning cell content drawn may be twice that for twenty winning cell content drawn, but the payout may be only one and one half times higher for matching the winning pattern in twenty versus thirty winning cell content drawn. Thus, the payout amount may be varied (e.g., increased) if the winning pattern was obtained in less than the predetermined fixed number of drawn winning cell content. For example, if the predetermined number of drawn winning cell content is thirty and the payout for that is thirty credits, then if the winning pattern is obtained within the first twenty drawn winning cell content then the payout for obtaining that may be forty-five credits. Other payout schemes may be used, and the invention is not limited to any particular scheme. Also, a game card 118 may have, in one embodiment, only one payout per game session 622.

A payout table (item 630 of FIG. 4) may also include adjustments for a player's subscription. For instance, the payout may be adjusted according to their subscription level. For example, a payout to a particular player may be increased for example, if the player has a multiple game subscription, multiple card subscription, high payment per game card or any combination of the three.

The payout table may also include adjustments for the time of day or day of the week. For example, the payouts may be increased for games played at particular times (e.g., higher payouts at night, even higher payouts on Sunday nights, etc.). These adjustments may be made because of the usually higher player counts at those times. Alternatively, it may be desired to attract more players to play at those times. By similar reasoning, the payout table may also be adjusted with changes in the subscriber or player count.

The payout may also be adjusted for numerous other criterion including, for example, frequent player credits. Of course, payout adjustments generally must meet any legal requirements for the gaming jurisdiction in which the game is played.

The payout table for each game session may also be supplemented by a jackpot that transfers from game session to game session. These types of jackpots are commonly called rolling or progressive jackpots. A rolling jackpot may be, for example, the same amount that transfers from game session to game session until it is paid out. A progressive jackpot is a rolling jackpot that increases as more game sessions, game cards or other criterion are played. Rolling or progressive jackpots are typically paid out for a difficult way to match the drawn winning cell content. For example, in one embodiment of the invention, if all cells of a cell grouping 114 are covered in the first twenty-five drawn winning cell content or no cells are covered after fifty drawn winning cell content, the rolling jackpot may be paid out.

The final payout may also be affected as to whether the game has a fixed payout for a win or whether the payout is shared (item 638 of FIG. 4). If the payout is fixed for a win, according to one embodiment, all players that have a game card winner for a certain type of win will be paid the amount listed in the payout table for the win. In this instance, each player is playing solely against the game operator.

If the payout is shared, then all players that have a game card winner for a certain type of win will be paid a total of the amount listed in the payout table. A particular way to win (e.g., two-line win) and its associated payout may be paid out only once during each game session with the payout shared equally by all players that win after the same number of winning cell content has been drawn or called. Each player may receive a share of the total payout depending upon how much he or she paid for the game or any other legal criteria.

The final payout may also be affected by bonus play, which is well-known in the gaming industry. Bonus play works to increase some payouts by offering the player a chance to multiply a payout.

One or more sessions may proceed concurrently. Parameters of the concurrent game sessions 622 may be the same, similar, or different. For example, drawn winning cell content may be used for one or more concurrent sessions if, for example, the predetermined set of cell content is the same for the one or more concurrent sessions. As a further example, the game card pattern of cells may be different in all the game sessions.

Additionally, game sessions may run continually, i.e. one game being run after another. When one game session ends, another session will begin immediately or in a short period of time. The game sessions may follow a precise time schedule so that players know when games will begin. For example, if game play in a session requires four and a half (4.5) minutes to complete, then the next game may start immediately or in a defined period (e.g., thirty seconds) to maintain to a schedule of games every five minutes (for instance, at :00, :05, :10, :15, :20, :25, :30, :35, :40, :45, :50, :55 of each hour). Because, according to on embodiment, the game sessions may run continually, it may be possible that a particular game session will have no game player or game card that is being played within the particular game session.

Prior to a game session, cell content on at least one game card may be chosen by a game player from the predetermined set of cell content for a particular game session. A game player may choose the cell content of a game card manually or may use a computer system to select the cell content for a particular game session. Alternatively, according to one embodiment of the invention, a computer system may automatically choose the cell content on at least one game card for a game player. Because, according to one embodiment, a computer system can both choose the cell content and play the game, a player need not configure and attend each game playing session, as discussed further below.

Referring to FIG. 1, the cell content 120 may be a free spot or a wild spot. A free or wild spot may be in any cell of the game card 118. Preferably, in one embodiment, there is only one free and/or wild spot per game card or cell grouping. It is also possible that there is no free or wild spot on a game card or in the predetermined set of cell content.

Besides a free or wild spot, the cell content 120 may be any letter or character, number, symbol, color, logo, shape, drawing or other item that may be represented in the cell. The cell content 120 may be, for example, a letter or character of any language (e.g., English, Russian, Japanese, Chinese, Greek, etc.). Cell content 120 may also be any random combination of letters or characters including words and phrases. Cell content 120 may also be a number expressed in any language (e.g., English, Chinese, Roman, etc.). The number may be represented by items (e.g., the number of stars in the cell or the dots on the face of a die or dice). The number may be negative, zero, positive, integer, fraction, decimal, real or imaginary. Preferably, according to one embodiment, the number is a positive integer. Cell content 120 may also be a symbol. For example, astrology, religion, printing and computer fonts, road signs, or law symbols may be used. Cell content 120 may be any color including black, white or shade of gray. Cell content may also be a logo of a company or product name or trademark. Any type of cell content may be used, and the invention is not limited to any particular type.

Preferably, cell content 120 of each cell 128 is unique (besides a blank spot) for the game card 118 to maximize the different possible cell content to match the drawn winning cell content for a game session. Also preferably, each game card and cell grouping in a game session is a unique combination of cell content 120 for that game session.

Cells 128 of the game card 118 are generally arranged in a pattern. The pattern includes three components: shape of the cells, cell connectivity (or how the cells are connected to each other) and the size of the total pattern. For example, in FIG. 1 the cells are square and are attached to each other side-to-side in a three by nine (3×9) matrix. Cells may be of any shape, cell connectivity and pattern size combinations.

Cells 128 in a grouping 114 all have the same shape and size as shown in FIG. 1 or cells may have a different shape or size such as a combination of octagons and squares.

Shape of the cells 128 may be any shape including, but not limited to, a circular, triangle, square, pentagon or hexagon shape. Also, it is possible that all cells have different shapes. For example, various aspects of the invention may be implemented with a game card having cells with irregularly shaped walls. The cells 128 may be connected to each other side-to-side, corner-to-corner, point-to-point or any other method.

The winning pattern for a game session may be, any subset of all the cells in the associated game card or in the cell grouping. The winning pattern may be, for example, a random subset of all cells that may not appear to have a pattern. Preferably, the winning pattern may be a recognizable pattern of cells. The winning pattern may have only one way of being achieved and the winning pattern may or may not include the cell with the free or wild spot. The winning pattern may also be achieved in a number of different ways. Also, more than one winning pattern may be possible for a particular game session.

Winning cell content may be randomly drawn by hand or by computer system from the predetermined set of cell content for a game session. When the drawing is performed by hand, the winning cell content may be chosen, for example from pieces of paper out of a hat or drum, by using balls or discs in a rotating or air blown sphere, or any other method that can be used for drawing content for a game session (e.g., for the games of keno or bingo). Hand-drawn winning cell content may then be displayed or entered into a computer system. Preferably, the winning cell content is randomly drawn by computer system from the predetermined set of cell content for a particular game session.

After a winning cell content is drawn, a player may manually daub his or her game card(s) on paper or by whatever means the player is viewing the game proceedings (e.g., by daubing a game card in an interface of a computer system). Referring to FIG. 1, the game player may be able to manually daub a number by selecting (e.g., by clicking with a mouse or other selection device) the cell content (item 120) matching the drawn winning cell content on the actual ticket (114), on the “Recent Calls” board 128 which shows a certain number of the latest drawn winning cell content, or on the “Call Board” 104. Selecting (e.g., by clicking on) the “Recent Calls” board or on the “Call Board” may automatically daub all instances of a particular drawn winning cell content. When the player (or the computer) daubs a matching cell content, the matching cell content may change color, the background may change color, or both may change color.

The game player may view the game proceedings using television, wireless or line telephone with display, handheld device, kiosk, computer or in person. For example, the game player may operate a computer system that has an Internet-enabled interface (e.g., using Macromedia Flash or Java) and the computer system may display streamed game information within that interface. It should be appreciated that any interface may be used to display game proceedings and that the invention is not limited to any particular interface. Depending upon the viewing medium, it may be necessary to download game information prior to viewing while another viewing medium may allow viewing of the streamed game information.

When a player matches enough winning cell content to obtain a winning pattern for a game session, the player informs the game operator that they are a winner. If the game player is playing the game in person, this act of informing may include raising one's hand or visually indicating that he or she has a winner. The game operator then verifies that the game player won by checking the daubed game card cell content against the drawn winning cell content. If the game player plays the game remotely, for instance over the web or interactive television, or if the game operator is a computer system, then other electronic or voice indication method may be necessary to authenticate and verify the game player and the winning game card. Such methods are well-known in the remote and electronic gaming industry.

In one embodiment, a computer system (e.g., a personal computer PC, set top box, PDA, phone) may automatically daub the matching cell content of each game card being played in a game session after each drawn winning cell content. The game player may view the game proceedings using any interface including a television, a wireless or other type of telephone having a display, a handheld device, a kiosk or computer. However, because the computer is adapted to automatically daub matching cell content, the game player may decide not to observe the drawing of winning cell content.

The computer system may then automatically determine when a game card is a winner. Such a result may be automatically authenticated and verified by the computer system. In this instance, the computer system may then notify the game player that he or she has won and what the winnings are after the computer has consulted a predetermined payout table (630 of FIG. 4 as described above). The computer may also determine if the winning needs to be shared with other winning game cards. Notification of winning to a game player may occur by mail, e-mail, computer web or network, telephone, television, pager, fax, kiosk or any other method.

When the computer system daubs matching cell content on one or more game cards, the computer system may also determine the game card(s) and the associated player identity(ies) that are closest to winning after each drawn winning cell content. The computer system may then display the game card(s) or the identity of the game player(s) closest to winning to all game players observing the game session. The computer system may also choose to display only one or a subset of all the game cards or identities of players closest to winning to a particular game player observing the game session.

Likewise, the computer may automatically display to a player his or her game card and/or cell grouping closest to winning. This option may be selected or deselected by the player.

After a winner is authenticated and verified, the computer system may then notify all game players observing the game session that a win has occurred. Additionally, the computer system may display the winning game card, the winning player's identity or the payout. Because the game session does not end until a predetermined fixed number of winning cell content is drawn, it is possible for this notification to occur several times, each time for a different game card during a particular game session.

During a period of time between game sessions, a game operator may make announcements, rest, or perform any number of actions. If the game is played using a computer system, advertisements, sponsorships, public service announcements or any visual or auditory content may be inserted into these periods. Advertisements, and other content may also be inserted into the game display during a game session.

In the configuration where the computer automatically daubs the game cards for the players, it may be beneficial to allow a game player to remotely access information indicating the results of a game session after the session has completed. In this manner, a player may not need to attend a particular game session, as results of each session may be accessed at a later time. Further, the player need not access the game session results from a same interface at which the game was played or subscribed. Remote access may be gained, for example, by kiosk, telephone, television, computer, handheld device or any other device or system that is appropriate. Information that may be accessed regarding a past game session may include whether the player won or lost, what the player's payout was, or other information relating to the past game session.

A game player may also be able to replay or review a past game session using a video-enabled device. For instance, a kiosk, telephone having a display, television, computer or handheld device may be used to replay a past game session. By accessing a selected game session in the computer system, a game player may be able to see a past game session as it occurred, the winning cards and winning game player identity(ies), the drawn winning cell content, or possibly any other aspect of the game session of interest.

Preferably, the game, its game sessions, and the game play are partially or fully automated using one or more computer systems. A computer system may be a single computer that may be a supercomputer, minicomputer or a mainframe or personal computer. A computer system used to run a game and its associates sessions and may also include any combination of computer system types that cooperate to accomplish system-level tasks. Multiple computer systems may also be used to run a game. The computer system also may include input or output devices, displays, or storage units. It should be appreciated that any computer system or systems may be used, and the invention is not limited to any number, type, or configuration of computer systems.

A computer system that executes a game according to various embodiments of the invention, may include, for example, three system components. One system component may handle payment, subscription and/or AMOE by players to enter the game sessions. Another system component may handle playing and viewing the game and a third system may handle payouts. Such a game system may also be connected (e.g., by direct line or network) to other computer systems including systems for handling casino or hotel loyalty programs, reservations, in-room television viewing, gambling floor kiosks, or other systems. Connections to other computer systems may be performed using one or more of the system components described below.

A payment component may include one or more of a number of well-known systems. For example, a player may be able to pay to play one or more games using a telephone and speaking with a call center representative who inputs player, payment and subscription information manually into a computer using a user interface. In the computer, data may be stored in a data which is stored in a memory of the computer system. As used herein, a “data structure” is an arrangement of data defined by computer-readable signals. These signals may be read by a computer system, stored on a medium associated with a computer system (e.g., in a memory, on a disk, etc.) and may be transmitted to one or more other computer systems over a communications medium such as, for example, a network. Also as used herein, a “user interface” or “UI” is an interface between a human user and a computer that enables communication between a user and a computer. Examples of UIs that may be implemented with various aspects of the invention include a graphical user interface (GUI), a display screen, a mouse, a keyboard, a keypad, a track ball, a microphone (e.g., to be used in conjunction with a voice recognition system), a speaker, a touch screen, a game controller (e.g., a joystick) etc, and any combinations thereof.

Player information may also be entered into a payment system component. Player information that may be input includes name, address, telephone number and age, and payment information may include credit or debit card number or loyalty account information. Also, as discussed above, various aspects of the present invention relate to subscription gaming for wagering games of chance. Subscription information may be input, including, for example, a first game session date and time, a number of game sessions to be played, a number of game pieces to be played per game session and bet per game piece. Based upon the payment and subscription information, the call center representative may verify that the payment information is valid and that enough credit or funds is available for the player's desired subscription.

A similar system may exist for players entering using the mail or a post card AMOE except the call center may be replaced by a mail center having representatives that enter information into one or more computers via a user interface. For example, a cashier that works at a casino or at a lottery outlet and interacts directly with players that pay cash or credit to play, may also have the ability to input player, account and subscription information for AMOE players using a user interface of a computers.

Computer systems or pay engines for handling electronic or online payment and subscriptions may also be used. Such systems are well-known, and include such systems as Paypal, iKobo, Verisign, and other systems. Using such a system, a player interacts with a user interface to input information into a payment data structure that may be transferred to one or more payment systems (e.g., PayPal).

Various pay systems and one or more user interfaces may be located on computer systems coupled by a network with the computer system(s) storing data having player, account and subscription information. As used herein, a “network” or a “communications network” is a group of two or more devices interconnected by one or more segments of transmission media or active communications equipment on which communications may be exchanged between the devices.

The above examples are merely illustrative embodiments of a pay system component. It should be appreciated that an illustrative embodiment is not intended to limit the scope of the invention, as any of numerous other implementations of the pay system, for example, variations of online payment, are possible and are intended to fall within the scope of the invention. For example, the payment system may include using pay-per-view systems associated with interactive television or the pay engine may additionally deliver a receipt to the player by either e-mail or mail. None of the claims set forth below are intended to be limited to any particular implementation of a pay system unless such claim includes a limitation explicitly reciting a particular implementation.

Payout systems are also well known. Any of a number of standard systems or payout engines for making payouts for winning may be used. For example, a standard application programming interface such as ‘Quicken’ (Intuit Inc., Mountain View, Calif., USA) may be used to write and mail checks or credit a debit card, credit card (if legal in the jurisdiction of play) or loyalty account. ‘Quicken’ may obtain the payout information by accessing a payout data structure across a network. As used herein, an “application programming interface” or “API” is a set of one or more computer-readable instructions that provide access to one or more other sets of computer-readable instructions that define functions, so that such functions can be configured to be executed on a computer in conjunction with an application program.

‘Quicken’ is merely an illustrative embodiment of the payout system. Such an illustrative embodiment is not intended to limit the scope of the invention, as any of numerous other implementations of the payout system, for example, variations of online payout, are possible and are intended to fall within the scope of the invention. Additionally, a cashier may also have access to payout information using a user interface to the payout data structure through a network; the cashier (e.g., at a casino or lottery outlet) then makes a payment to the winning player based upon the accessed information. None of the claims set forth below are intended to be limited to any particular implementation of a pay system unless such claim includes a limitation explicitly reciting a particular implementation.

A game playing and viewing system according to one embodiment of the invention may comprise of a number of components for performing specific functions. These components may include, for example, storage means that store data structures having information relating to game configuration and game play. For example, such information may include game variation information, present game session information, game session history and win history. A game playing and viewing system may also include components to access payment and payout data structures.

FIG. 4 illustrates various embodiments of a data structure associated with a game session 622. A game session may include a number of predetermined items including session date and time 632, session length 640, payout table 630, payout type 638, game card (and cell grouping) pattern 628, winning pattern 608, set of cell content 626 and the number of winning content to be drawn 624 as well as who the players are and the game card(s) 600 assigned to each. In one embodiment of the invention, a game piece(s) adds another level of complexity to a game session.

From a predetermined number of winning content to be drawn 624 and set of cell content 626, a game session has associated with it winning cell content 634 that identifies the content necessary to determine a winning card. As discussed, content 634 may be drawn by hand or by the computer system. Further, the specific draw order of the winning content may be stored for later reference (e.g., for replay at a later time). A game session may also have one or more associated winners 644. According to another embodiment, it is possible that a particular session may have no winners.

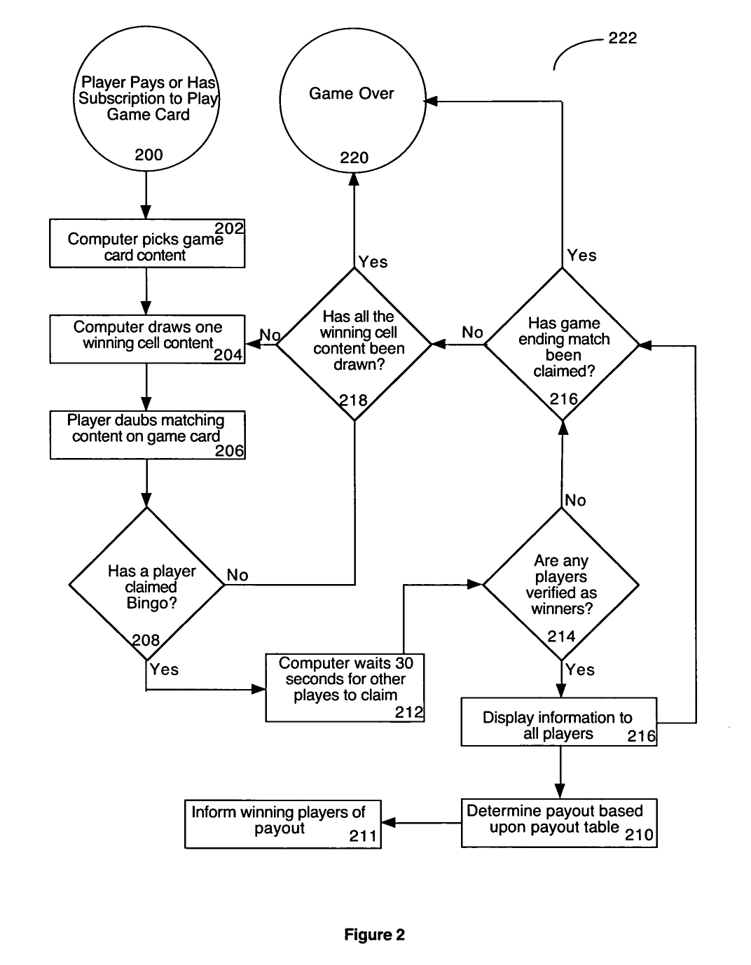

The game playing and viewing system may also include a game engine. A game engine may perform, for example, functions according to process 222 as shown in FIG. 2. Referring to FIG. 2, a game session may proceed for a player (e.g., player 620) with a game piece (e.g., game piece 102) having a game card (e.g., game card 118). At block 200, the player pays for a game piece in the game session. At block 202, the computer chooses a game piece having one game card and the card cell content. At block 204, the computer draws the first winning cell content. The player then checks the game card for a match and daubs the matching cell content, if necessary (at block 206). At block 208, the player claims bingo (e.g., by clicking on the BINGO button 110 in FIG. 1) if they have a bingo. If no player claims bingo, the computer determines if the maximum number of winning cell content has been drawn at block 218 and may proceed to draw another winning cell content (204) and continue the cycle until the predetermined number of winning cell content has been drawn or until a winner is found. When all the winning cell content has been drawn at 218 and the game card is not a winner, then the computer may notify the player that the card is not a winner, invite the player to play again or any number of actions.

If the player claims bingo at 208, then the computer waits at block 212 for a predetermined amount of time (e.g., 15 or 30 seconds) for other players to make a claim. At block 214, the computer may then proceed to verify the players that claim a win. If a player(s) is verified as a winner, then the computer may notify all players about the winner at step 216. The computer may also display the winning game card and/or player information to all the game players. Winning player information that may be displayed may include name, city, state and country and/or any other identifying information. If multiple winners occur simultaneously, all winners or winning game cards may be displayed at one time or sequentially. It may also be possible that winners or winning game cards may be selectively displayed to particular game players. For instance, if numerous winners occur at one time, a player in Bismarck, N.D. may be shown only the winning player information or game card that occurred closest to him or her, say in Pierre, S.D. versus some other location (e.g., Boston, Mass.).

The computer may further determine the payout amount at block 210 and notify the player of the payout amount (e.g., in a game play interface, e-mail, etc.) at block 211.

After a win has been claimed and verified, the computer may then continue drawing winning cell content at block 204 if a game ending win (e.g., the previously described full house) has not occurred or the maximum number of winning cell content has not been drawn.

After a game card is found not to be a winner, the computer may also determine whether the card is the closest to winning if there have been no winners (e.g., at block 214). Any of a number of criteria may be used for determining the card closest to winning. For example, a computer may determine that a card is the closest to winning based upon having the highest number of matching cell content or the least number of cells to match to make the winning pattern. A card determined to be closest to winning may then be displayed to all game players.

It should be appreciated that game play process 222 may include more or less acts as shown in FIG. 2, and that the invention is not limited to any particular number of order of acts. (e.g., the order illustrated in FIG. 2) as the acts may be performed in other orders, may include additional acts and one or more of the acts of process 222 may be performed in series or in parallel to one or more other acts, or parts thereof. For example, acts 216 and 210, or parts thereof, may be performed in parallel, and act 208 may be performed at any point during performance of process 222.

Process 222 is merely an illustrative embodiment of a method for performing game play using a game engine. Such an illustrative embodiment is not intended to limit the scope of the invention, as any of numerous other implementations for performing game play using a game engine. None of the claims set forth below are intended to be limited to any particular implementation of a method of game play for a game engine, unless such claim includes a limitation explicitly reciting a particular implementation.

Process 222, acts thereof and various embodiments and variations of these methods and acts, individually or in combination, may be defined by computer-readable signals tangibly embodied on a computer-readable medium, for example, a non-volatile recording medium, an integrated circuit memory element, or a combination thereof. Such signals may define instructions, for example, as part of one or more programs, that, as a result of being executed by a computer, instruct the computer to perform one or more of the methods or acts described herein, and/or various embodiments, variations and combinations thereof. Such instructions may be written in any of a plurality of programming languages, for example, Java, Visual Basic, C, C#, or C++, Fortran, Pascal, Eiffel, Basic, COBOL, etc., or any of a variety of combinations thereof. The computer-readable medium on which such instructions are stored may reside on one or more of the components of a general-purpose computer described above, and may be distributed across one or more of such components.

The computer-readable medium may be transportable such that the instructions stored thereon can be loaded onto any computer system resource to implement the aspects of the present invention discussed herein. In addition, it should be appreciated that the instructions stored on the computer-readable medium, described above, are not limited to instructions embodied as part of an application program running on a host computer. Rather, the instructions may be embodied as any type of computer code (e.g., software or microcode) that can be employed to program a processor to implement the above-discussed aspects of the present invention.

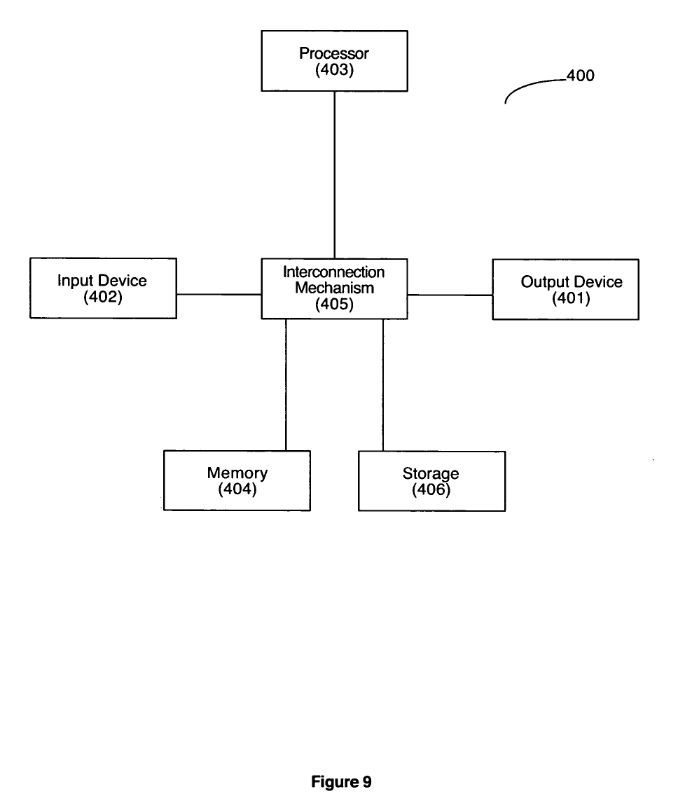

It should be appreciated that any single component or collection of multiple components of a computer system, for example, the computer system described below in relation to FIG. 9, that perform the functions described above with respect to describe or reference the method can be generically considered as one or more controllers that control the above-discussed functions. The one or more controllers can be implemented in numerous ways, such as with dedicated hardware, or using a processor that is programmed using microcode or software to perform the functions recited above.

Another component of the game playing and viewing system may include a software component (e.g., a driver) that streams video via a broadband, satellite or wireless medium to a user interface. If the game is played completely automatically, the user interface may be merely a video terminal including television with no user input means. Viewing access may be controlled by standard methods for conditional access including using set top box addresses, telephone numbers or internet protocol (IP) addresses.

The above is merely an illustrative embodiment of a game playing and viewing system. Such an illustrative embodiment is not intended to limit the scope of the invention, as any of numerous other implementations of a game playing and viewing system, for example, variations of conditional access, are possible and are intended to fall within the scope of the invention. None of the claims set forth below are intended to be limited to any particular implementation of a game playing and viewing system unless such claim includes a limitation explicitly reciting a particular implementation.

System 300, and components thereof such as the payment, payout and game engines, may be implemented using software (e.g., C, C#, C++, Java, or a combination thereof), hardware (e.g., one or more application-specific integrated circuits, processors or other hardware), firmware (e.g., electrically-programmed memory) or any combination thereof. One or more of the components of 300 may reside on a single system (e.g., the payment subsystem), or one or more components may reside on separate, discrete systems. Further, each component may be distributed across multiple systems, and one or more of the systems may be interconnected.

Further, on each of the one or more systems that include one or more components of 300, each of the components may reside in one or more locations on the system. For example, different portions of the components of 300 may reside in different areas of memory (e.g., RAM, ROM, disk, etc.) on the system. Each of such one or more systems may include, among other components, a plurality of known components such as one or more processors, a memory system, a disk storage system, one or more network interfaces, and one or more busses or other internal communication links interconnecting the various components.

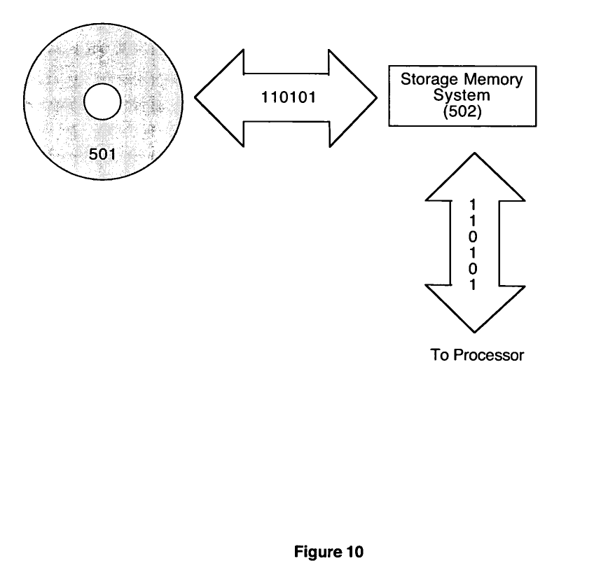

System 300 may be implemented on a computer system described below in relation to FIGS. 9 and 10.

System 300 is merely an illustrative embodiment of the game system. Such an illustrative embodiment is not intended to limit the scope of the invention, as any of numerous other implementations of the game system, for example, variations of 300, are possible and are intended to fall within the scope of the invention. For example, a parallel system for viewing by interactive television may include one or more additional video streamers specific for interactive television. None of the claims set forth below are intended to be limited to any particular implementation of the game system unless such claim includes a limitation explicitly reciting a particular implementation.

Various embodiments according to the invention may be implemented on one or more computer systems. These computer systems, may be, for example, general-purpose computers such as those based on Intel PENTIUM-type processor, Motorola PowerPC, Sun UltraSPARC, Hewlett-Packard PA-RISC processors, or any other type of processor. It should be appreciated that one or more of any type computer system may be used to partially or fully automate play of the described game according to various embodiments of the invention. Further, the software design system may be located on a single computer or may be distributed among a plurality of computers attached by a communications network.

A general-purpose computer system according to one embodiment of the invention is configured to perform any of the described game functions including but not limited to player subscription or payment, game piece or card selection, drawing winning cell content, daubing matching cell content on game cards, determining winners and paying winners. It should be appreciated that the system may perform other functions, including network communication, and the invention is not limited to having any particular function or set of functions.

For example, various aspects of the invention may be implemented as specialized software executing in a general-purpose computer system 400 such as that shown in FIG. 9. The computer system 400 may include a processor 403 connected to one or more memory devices 404, such as a disk drive, memory, or other device for storing data. Memory 404 is typically used for storing programs and data during operation of the computer system 400. Components of computer system 400 may be coupled by an interconnection mechanism 405, which may include one or more busses (e.g., between components that are integrated within a same machine) and/or a network (e.g., between components that reside on separate discrete machines). The interconnection mechanism 405 enables communications (e.g., data, instructions) to be exchanged between system components of system 400. Computer system 400 also includes one or more input devices 402, for example, a keyboard, mouse, trackball, microphone, touch screen, and one or more output devices 401, for example, a printing device, display screen, speaker. In addition, computer system 400 may contain one or more interfaces (not shown) that connect computer system 400 to a communication network (in addition or as an alternative to the interconnection mechanism 405.

The storage system 406, shown in greater detail in FIG. 10, typically includes a computer readable and writeable nonvolatile recording medium 501 in which signals are stored that define a program to be executed by the processor or information stored on or in the medium 501 to be processed by the program. The medium may, for example, be a disk or flash memory. Typically, in operation, the processor causes data to be read from the nonvolatile recording medium 501 into another memory 502 that allows for faster access to the information by the processor than does the medium 501. This memory 502 is typically a volatile, random access memory such as a dynamic random access memory (DRAM) or static memory (SRAM). It may be located in storage system 406, as shown, or in memory system 404, not shown. The processor 403 generally manipulates the data within the integrated circuit memory 404, 502 and then copies the data to the medium 501 after processing is completed. A variety of mechanisms are known for managing data movement between the medium 501 and the integrated circuit memory element 404, 502, and the invention is not limited thereto. The invention is not limited to a particular memory system 404 or storage system 406.

The computer system may include specially-programmed, special-purpose hardware, for example, an application-specific integrated circuit (ASIC). Aspects of the invention may be implemented in software, hardware or firmware, or any combination thereof. Further, such methods, acts, systems, system elements and components thereof may be implemented as part of the computer system described above or as an independent component.

Although computer system 400 is shown by way of example as one type of computer system upon which various aspects of the invention may be practiced, it should be appreciated that aspects of the invention are not limited to being implemented on the computer system as shown in FIG. 9. Various aspects of the invention may be practiced on one or more computers having a different architecture or components that that shown in FIG. 9.

Computer system 400 may be a general-purpose computer system that is programmable using a high-level computer programming language. Computer system 400 may be also implemented using specially programmed, special purpose hardware. In computer system 400, processor 403 is typically a commercially available processor such as the well-known Pentium class processor available from the Intel Corporation. Many other processors are available. Such a processor usually executes an operating system which may be, for example, the Windows 95, Windows 98, Windows NT, Windows 2000 (Windows ME) or Windows XP operating systems available from the Microsoft Corporation, MAC OS System X available from Apple Computer, the Solaris Operating System available from Sun Microsystems, or UNIX available from various sources. Many other operating systems may be used.

The processor and operating system together define a computer platform for which application programs in high-level programming languages are written. It should be understood that the invention is not limited to a particular computer system platform, processor, operating system, or network. Also, it should be apparent to those skilled in the art that the present invention is not limited to a specific programming language or computer system. Further, it should be appreciated that other appropriate programming languages and other appropriate computer systems could also be used.

One or more portions of the computer system may be distributed across one or more computer systems (not shown) coupled to a communications network. These computer systems also may be general-purpose computer systems. For example, various aspects of the invention may be distributed among one or more computer systems configured to provide a service (e.g., servers) to one or more client computers, or to perform an overall task as part of a distributed system. For example, various aspects of the invention may be performed on a client-server system that includes components distributed among one or more server systems that perform various functions according to various embodiments of the invention. These components may be executable, intermediate (e.g., IL) or interpreted (e.g., Java) code which communicate over a communication network (e.g., the Internet) using a communication protocol (e.g., TCP/IP).

It should be appreciated that the invention is not limited to executing on any particular system or group of systems. Also, it should be appreciated that the invention is not limited to any particular distributed architecture, network, or communication protocol.

Various embodiments of the present invention may be programmed using an object-oriented programming language, such as SmallTalk, Java, C++, Ada, or C# (C-Sharp). Other object-oriented programming languages may also be used. Alternatively, functional, scripting, and/or logical programming languages may be used. Various aspects of the invention may be implemented in a non-programmed environment (e.g., documents created in HTML, XML or other format that, when viewed in a window of a browser program, render aspects of a graphical-user interface (GUI) or perform other functions). Various aspects of the invention may be implemented as programmed or non-programmed elements, or any combination thereof.

Having now described some illustrative embodiments of the invention, it should be apparent to those skilled in the art that the foregoing is merely illustrative and not limiting, having been presented by way of example only. Numerous modifications and other illustrative embodiments are within the scope of one of ordinary skill in the art and are contemplated as falling within the scope of the invention. In particular, although many of the examples presented herein involve specific combinations of method acts or system elements, it should be understood that those acts and those elements may be combined in other ways to accomplish the same objectives. Acts, elements and features discussed only in connection with one embodiment are not intended to be excluded from a similar role in other embodiments. Further, for the one or more means-plus-function limitations recited in the following claims, the means are not intended to be limited to the means disclosed herein for performing the recited function, but are intended to cover in scope any means, known now or later developed, for performing the recited function.

As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, shall be closed or semi-closed transitional phrases, as set forth, with respect to claims.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

1. A wagering game of chance wherein a game player subscribes to play multiple game sessions, the game comprising:
one or more game pieces assigned to each player, wherein each game piece includes one or more game cards, wherein each of the one or more game cards includes two or more groupings of a plurality of cells arranged in a pattern, wherein each of the one or more game pieces includes a set of game cards having a same set of two or more groupings of a plurality of cells arranged in a pattern, and wherein the number of total cells on each of the one or more game cards that contains content chosen randomly from a predetermined set of cell content is equal to the number of items in the predetermined set of cell content;
a winning pattern for the game session;
a fixed number of winning cell content drawn from a known set of content; and
a payout based upon a predetermined payout table.

2. The game according to claim 1, wherein the content of the cells is evenly distributed among all the rows or columns of cells in the two or more groupings of cells on a game card.

3. The game according to claim 1, wherein every game piece assigned in a game session is unique.

4. The game according to claim 1, wherein every card in a game session is unique.

5. The game according to claim 1, wherein every grouping of a plurality of cells in a game session is unique.

6. The game according to claim 1, wherein the predetermined set of cell content includes at least one of a number, a letter, a shape, a symbol, a color, a logo and a drawing.

7. The game according to claim 1, wherein each item in the predetermined set of cell content is used only once on each game card.

8. The game according to claim 1, wherein the cell content may be at least one of a free spot and a wild spot.

9. The game according to claim 1, wherein the predetermined set of cell content is divided into subsets, at least one of which is assigned for use in a particular group of cells.

10. The game according to claim 1, wherein every row and column in the two or more groupings of a plurality of cells has at least one cell containing one or more items from the predetermined set of cell content.

11. The game according to claim 10, wherein the grouping of a plurality of cells includes 3 rows and 9 columns.

12. The game according to claim 10, wherein the grouping of a plurality of cells is 9 rows and 3 columns.

13. The game according to claim 1, wherein the player pays to play with at least one of money and loyalty points.

14. The game according to claim 13, wherein the player pays by at least one of cash, a debit card, a credit card, an account credit, and a loyalty program credit.

15. The game according to claim 14, wherein the player is permitted to automatically renew the subscription.

16. The game according to claim 1, wherein each player plays against an operator of the game.

17. The game according to claim 1, wherein each player plays against the other players.

18. The game according to claim 1, wherein each player plays the game on at least one of a television, a personal computer, a kiosk, a handheld device, a telephone having a display, a kiosk and in person.

19. The game according to claim 1, wherein the payout for winning depends upon the number of winning cell content drawn before obtaining the winning pattern.

20. The game according to claim 1, wherein the payout for winning decreases as the number of winning cell content drawn increases to obtain the winning pattern.

21. The game according to claim 1, wherein the payout for winning to a player is increased with a corresponding increase in payment by the player to play.

22. The game according to claim 1, wherein the payout to a player for winning the game is divided among each of a plurality of winning players.

23. The game according to claim 1, wherein there may be at least one progressive jackpot.

24. The game according to claim 1, wherein the payout table is not directly determined by the odds of winning with or without a fee to the gaming operator.

25. The game according to claim 1, wherein the payout for winning may include at least one of money, a credit, merchandise, and loyalty points.

26. The game according to claim 1, wherein the payout for winning money is performed by providing at least one of cash, a check, a debit card, and an account credit.

27. The game according to claim 1, wherein the payout for winning loyalty points is performed by providing at least one of a loyalty program credit and an account credit.

28. The game according to claim 1, wherein the game sessions are run continually.

29. The game according to claim 1, wherein a game playing computer system randomly picks the winning cell content from a predetermined set of content.

30. The game according to claim 29, wherein the player manually daubs his or her at least one game card.

31. The game according to claim 30, wherein the player tells the gaming operator or computer system that the game winning pattern has been matched.

32. The game according to claim 31, wherein the player and the winning game card must be verified and authenticated by the gaming operator or computer system.

33. The game according to claim 32, wherein a game playing computer system displays to all players when there is a winner.

34. The game according to claim 33, wherein a game playing computer system displays to all players at least one of the winning game card and the winning player.

35. The game according to claim 1, wherein a game playing computer system determines at least one of a game card or a player closest to winning.

36. The game according to claim 35, wherein a game playing computer system displays to all players at least one of the game card and player closest to winning.

37. The game according to claim 1, wherein a game playing computer displays to each player the game card or grouping of a plurality of cells of his or her own that is closest to winning.

38. The game according to claim 33, wherein the computer system automatically notifies a player of winnings.

39. The game according to claim 1, wherein a player may access his or her results for past gaming sessions remotely at any time.

40. The game according to claim 39, wherein the results for past gaming sessions are at least one of a win, a payout, and a loss.

41. The game according to claim 40, wherein a player gains remote access through at least one of a group including a kiosk, a phone, a handheld device, a television and a computer.

42. The game according to claim 1, wherein a player replays a past game session remotely at any time.

43. The game according to claim 42, wherein a player gains remote access through at least one of a group including a kiosk, a telephone having a display, a handheld device, a television and a computer.

44. The game according to claim 1, wherein the game sessions are run continually, and wherein advertising streams are inserted into the display during the game session.

45. The game according to claim 1, wherein the player may enter a game session through an alternative method of entry (AMOE).

46. The game according to claim 1, wherein the game and its associated game session are played using one or more computer systems.

47. The game according to claim 1, wherein the cells of each of the one or more game cards is chosen randomly by a computer system.

48. The game according to claim 1, wherein the game is available on a network.

49. The game according to claim 48, wherein the network is a cable system, the Internet, or wireless.

50. The game according to claim 1, wherein each game session includes at least two winning patterns.

51. The game according to claim 50, wherein the at least two winning patterns have progressive complexity.

52. The game according to claim 50, wherein a winning pattern is no longer available after being matched for a win by at least one of the players.

53. The game according to claim 1, wherein the payout table is adjusted for at least one of a time of day and a day of the week of the game.

54. The game according to claim 1, wherein the payout table is adjusted for at least one of a number of subscribers and a number of actual players.

55. The game according to claim 1, wherein the player daubs cell content matching drawn winning cell content by selecting the matching cell content.

56. The game according to claim 1, wherein the player daubs all cell content matching a drawn winning cell content by selecting a listing of drawn winning cell content.

57. The game according to claim 1, wherein the player daubs all cell content matching a drawn winning cell content by selecting a listing of recent drawn winning cell content.

58. The game according to claim 1, wherein the grouping of a plurality of cells is nine rows by three columns.

59. A method for playing a wagering game of chance, the method comprising acts of:
assigning one or more games to each player, wherein each game piece includes one or more game cards, wherein each of the one or more game cards includes two or more groupings of a plurality of cells arranged in a pattern, wherein each of the one or more game pieces includes a set of game cards having a same set of two or more groupings of a plurality of cells arranged in a pattern, and wherein the number of total cells on each of the one or more game cards that contains content chosen randomly from a predetermined set of cell content is equal to the number of items in the predetermined set of cell content;
determining a winning pattern for the game session;
drawing a fixed number of winning cell content from a known set of content; and
determining a payout based upon a predetermined payout table.

60. The method according to claim 59, further comprising an act of distributing content among the plurality of cells evenly across all the rows or columns of cells in the two or more groupings of cells on a game card.

61. The method according to claim 59, further comprising an act of assigning a unique game piece in a game session.

62. The method according to claim 59, further comprising an act of assigning a unique game card in a game session.

63. The method according to claim 59, further comprising an act of assigning a unique grouping of a plurality of cells in a game session.

64. The method according to claim 59, wherein the act of determining a payout further comprises an act of determining the payout based on the number of winning content drawn before obtaining the winning pattern.

65. The method according to claim 59, further comprising an act of decreasing the winning payout and the number of winning content drawn increases.

66. The method according to claim 59, further comprising an act of increasing the payout for winning to a player with a corresponding increase in payment by the player to play.

67. The method according to claim 59, further comprising an act of permitting an entry into a game session through an alternative method of entry (AMOE).

68. The method according to claim 59, wherein the grouping of the plurality of cells is formed in nine rows by three columns.

69. A system for playing a wagering game of chance, the system comprising:
means for assigning one or more games to each player, wherein each game piece includes one or more game cards, wherein each of the one or more game cards includes two or more groupings of a plurality of cells arranged in a pattern, wherein each of the one or more game pieces includes a set of game cards having a same set of two or more groupings of a plurality of cells arranged in a pattern, and wherein the number of total cells on each of the one or more game cards that contains content chosen randomly from a predetermined set of cell content is equal to the number of items in the predetermined set of cell content;
means for determining a winning pattern for the game session;
means for drawing a fixed number of winning cell content from a known set of content; and
means for determining a payout based upon a predetermined payout table.

70. The system according to claim 69, further comprising means for distributing content among the plurality of cells evenly across all the rows or columns of cells in the two or more groupings of cells on a game card.

71. The system according to claim 69, further comprising means for assigning a unique game piece in a game session.

72. The system according to claim 69, further comprising means for assigning a unique game card in a game session.

73. The system according to claim 69, further comprising means for assigning a unique grouping of a plurality of cells in a game session.

74. The system according to claim 69, further comprising means for determining the payout based on the number of winning content drawn before obtaining the winning pattern.

75. The system according to claim 69, further comprising means for decreasing the winning payout and the number of winning content drawn increases.

76. The system according to claim 69, further comprising means for increasing the payout for winning to a player with a corresponding increase in payment by the player to play.

77. The system according to claim 69, further comprising means for permitting an entry into a game session through an alternative method of entry (AMOE).

78. The system according to claim 69, wherein the grouping of the plurality of cells is formed in nine rows by three columns.
